(19) United States
(12) Patent Application Publication
(10) Pub. No.: US 2023/0339355 A1
(43) Pub. Date: Oct. 26, 2023

(54) Portable Rapid Vehicle Charging System

(71) Applicant: Lawrance Hester, Murrieta, CA (US)

(72) Inventor: Lawrance Hester, Murrieta, CA (US)

(21) Appl. No.: 18/306,049

(22) Filed: Apr. 24, 2023

Related U.S. Application Data
(60) Provisional application No. 63/335,135, filed on Apr. 26, 2022.

(51) Int. Cl. B60L 53/62; H02J 7/00; B60L 53/30; B60L 53/18; G06Q 50/06; G06Q 20/18

(52) U.S. Cl. CPC B60L 53/62; H02J 7/0047; H02J 7/007; B60L 53/305; B60L 53/18; G06Q 50/06; G06Q 20/18

(57) ABSTRACT

A system may be provided for a portable rapid vehicle charger. The charging system, for example, includes a charging unit. The charging unit may include an enclosure for the charging unit mounted on a utility pole or a streetlight pole. The charging unit may further include one or more transformers coupled with one or more power lines supported by the pole to receive an input voltage. The charging unit may further include at least one charging outlet coupled with the one or more transformers. The charging outlet may be connectable to a charging port of a vehicle to provide charge to the vehicle for a first time-period.

### TECHNOLOGICAL FIELD

The present disclosure generally relates to a rapid charging system, and more particularly to a portable rapid charging system for electric vehicles (EV) capable of being retrofitted onto existing utility poles.

### BACKGROUND

With advancement in the field of automobiles, demand of electric vehicles (EVs) is on a rise. An electric vehicle (EV) is a type of vehicle that runs on electricity rather than traditional gasoline or diesel fuel. The EVs may be more environmentally friendly than traditional gasoline-powered vehicles, producing less greenhouse gas emissions and causing less air pollution than the traditional gasoline-powered vehicles. Typically, the EVs use equipments such as electric motors and batteries to power their movement. Since EVs includes batteries, such batteries are required to be recharged regularly for continuous operation of the vehicle.

Nowadays, there is a growing demand for charging of such EVs as a large number of users may utilize the EVs to travel to far away distances. Currently, the charging of the EVs may be available only at certain locations, such as designated public charging stations or at a personal home space of the users, where the users of the EV may charge their EVs. However, the charging of the EV at the personal home space may be difficult due to multiple reasons, such as unavailability of parking space, electricity fluctuations, and so forth. Therefore, the users may have to rely on the designated public charging stations to charge their EVs.

Moreover, conventional designs for establishing the public charging stations may require large-scale construction at prominent and accessible locations, such as shopping centers, businesses, and apartments. Such public charging stations require electricity available at the location and constructing standalone charging stations at those locations. Further, the public charging stations requires large parking spots dedicated for the EVs. Typically, construction of such public charging stations may be expensive and time consuming. Furthermore, the parking lot used for the public charging stations may go unutilized when there isn't a current need for EV parking in the parking spots. In addition to it, the parking lot may be full and there may be no availability of a charging unit at a needed hour of time due to high demand at the public charging stations.

Therefore, there is a demand for EV charging stations that may be inexpensively built, easily assessable and may be able to provide charging of the EVs during high demand.

### BRIEF SUMMARY

A system, a method, and a computer program product are provided herein that focuses on rapid charging of electric vehicles at public places.

In one aspect, a charging system for portable rapid charger for vehicles is disclosed. The charging system comprises of a charging unit. The charging unit further includes an enclosure for the charging unit. The enclosure may have to be mounted on a pole. The charging unit further includes one or more transformers that may be coupled with one or more power lines supported by the pole to receive an input voltage. The charging unit may further include at least one charging outlet that may be coupled with the one or more transformers, wherein the charging outlet is connectable to a charging port of a vehicle to provide a charge to the vehicle for a first time-period.

In additional embodiments, the charging system further comprises of one or more processors (hereinafter referred as processor) configured to receive a first user input via at least one of a user device or a display screen associated with the charging unit, wherein the first user input is associated with an initiation of charging of the vehicle. The processor is further configured to control a movement of a cord connected to the charging outlet of the charging system based on the reception of the first user input, wherein controlling the movement of the cord corresponds to a downward traction of the cord along with the charging outlet. The processor is further configured to receive connection information from at least one of the charging outlet, the user device, or the display screen, wherein the connection information indicates that the charging outlet is connected with the charging port of the vehicle. The processor is further configured to control a flow of electricity from the charging unit to the vehicle via the charging outlet to charge the vehicle for the first time-period.

In additional system embodiments, the processor is further configured to receive a second user input via at least one of the user device or the display screen associated with the charging unit, wherein the second user input is associated with a stoppage of charging of the vehicle. The processor is further configured to control the movement of the cord based on the reception of the received disconnection information, wherein controlling the movement includes upward traction of the cord along with the charging outlet. The processor is further configured to receive disconnection information from at least one of: the charging outlet, the user device, or the display screen, wherein the disconnection information indicates that the charging outlet is disconnected from the charging port of the vehicle after the first time-period. The processor is further configured to control the movement of the cord along with the charging outlet based on the reception of the received disconnection information, wherein controlling the movement comprises upward traction of the cord along with the charging outlet.

In additional system embodiments, the processor is further configured to calculate an amount to be paid by a user of the vehicle based on one or more factors. The one or more factors may be associated with at least one of an electricity consumed by the vehicle, the first time-period, and a user profile of a user associated with the vehicle. The processor is further configured to render the calculated amount at least one of the user device or the display screen. The processor is further configured to receive confirmation information associated with a successful payment of the calculated amount and control the movement of the cord along with the charging outlet based on the reception of the received disconnection information and the confirmation information.

In additional system embodiments, the charging system further includes a payment device mounted on the enclosure and configured to accept one or more payments via at least one of a credit card, a debit card, a prepaid card, a quick response (QR) code, a radio-frequency identification (RFID) card, a voucher code, a coupon code, or a contactless payment method.

In additional system embodiments, the charging system further includes a used disconnect switch disposed between an output of the one or more power lines and the one or more transformers. In additional system embodiments, the fused disconnect switch is a 50 Ampere fusible disconnect switch.

In additional system embodiments, the one or more transformers corresponds to one of a step-up transformer, a step-down transformer, or an isolation transformer. In additional system embodiments, the one or more transformers corresponds to a 277/240 volts transformer.

In additional system embodiments, the charging system further includes a printed circuit board with an onboard software, and wherein one or more processors are configured to utilize the onboard software to perform operations associated with the charging unit. In additional system embodiments, the enclosure is formed by one of a metal, a wood, or a plastic. In additional system embodiments, the enclosure comprises of one or more ventilation vents.

In additional system embodiments, the charging system further includes a set of light emitting diode (LED) indicators configured to indicate information about a set of parameters associated with the charging unit. The set of parameters associated with the charging unit includes at least one of a charging unit state parameter, a network parameter, and a payment parameter.

In additional system embodiments, the charging system further includes a server in communication with the charging unit via a communication network. The server is configured to perform operations associated with the charging unit.

In additional system embodiments, the pole corresponds to a utility pole or a streetlight pole.

In additional system embodiments, the charging system further includes a display screen associated with the charging unit, wherein the display screen is a touch screen configured to receive one or more inputs from a user of the vehicle or the charging system.

In one aspect, a method for charging of vehicles using a charging system is disclosed. The method includes receiving a first user input via at least one of a user device, or a display screen associated with a charging unit of a charging system. The first user input may be associated with an initiation of charging of a vehicle. The method further includes controlling a movement of a cord connected to a charging outlet of the charging system, based on the reception of the first user input. The controlling of the movement may include a downward traction of the cord along with the charging outlet. The method further includes receiving connection information from at least one of the charging outlet, the user device, or the display screen. The connection information may indicate that the charging outlet may be connected with the charging port of the vehicle. The method further includes controlling a flow of electricity from the charging unit to the vehicle via the charging outlet to charge the vehicle for a first time-period.

In additional method embodiments, the method includes receiving a second user input via at least one of the user device or the display screen associated with the charging unit. The second user input may be associated with a stoppage of charging of the vehicle. The method further includes controlling the flow of electricity from the charging unit to the charging port of the vehicle based on the reception of the second user input, to stop the charging of the vehicle after the first time-period. The method further includes receiving disconnection information from at least one of the charging outlet, the user device, or the display screen. The disconnection information may indicate that the charging outlet is disconnected from the charging port of the vehicle after the first time-period. The method further includes controlling the movement of the cord based on the reception of the received disconnection information, wherein the controlling the movement comprises upward traction of the cord along with the charging outlet.

In additional method embodiments, the method includes calculating an amount to be paid by a user of the vehicle based on one or more factors. The method further includes rendering the calculated amount on at least one of: the user device or the display screen. The method further includes receiving confirmation information associated with a successful payment of the calculated amount and controlling the movement of the cord along with the charging outlet based on the reception of the received disconnection information and the confirmation information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates an environment comprising a charging system for rapidly charging an electric vehicle, in accordance with one or more example embodiments;

FIG. 2 illustrates an exemplary block diagram of the charging system, in accordance with one or more example embodiments;

FIG. 3 is diagram that depicts a front perspective view of the charging unit of FIG. 1, in accordance with one or more example embodiments;

FIG. 4 is diagram that depicts a rear perspective view of the charging unit of FIG. 1, in accordance with one or more example embodiments;

FIG. 5A is diagram that depicts a front view of the charging unit of FIG. 1, in accordance with one or more example embodiments;

FIG. 5B is diagram that depicts a side view of the charging unit of FIG. 1, in accordance with one or more example embodiments;

FIG. 6 is diagram that depicts a line drawing of the charging unit of FIG. 1, in accordance with one or more example embodiments;

FIG. 7 is a diagram that illustrates exemplary operations for charging a vehicle using the charging system, in accordance with one or more example embodiments; and

FIG. 8 is a flowchart that illustrates an exemplary method for charging of a vehicle, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A rapid charging system for electric vehicles is provided herein in accordance with an example embodiment for rapidly charging an electric vehicle.

The rapid portable charging system for vehicles disclosed herein may be configured to charge the electric vehicles rapidly and safely. The disclosed charging system may be mounted on any type of poles such as utility poles or streetlight poles that are installed throughout a geographical region, such as a city and provide a feasible, effective, and efficient charging solution to users of the electric vehicles. Thus, as compared to traditional charging solutions that may require dedicated space and infrastructure, the disclosed charging system may reduce installation costs by a large margin (for example, around 70%) as the disclosed charging system utilizes existing poles for its installation. Moreover, the disclosed system may provide charging solutions to public who may not have access to a garage or private parking space with dedicated charging.

The disclosed charging solution may be installed at multiple easily accessible locations, and may provide ease of access to the users, thereby motivating the users to switch to using the electric vehicles. Therefore, the disclosed solution may aid in reduction of greenhouse effect and push towards net zero emission targets/carbon neutrality emissions.

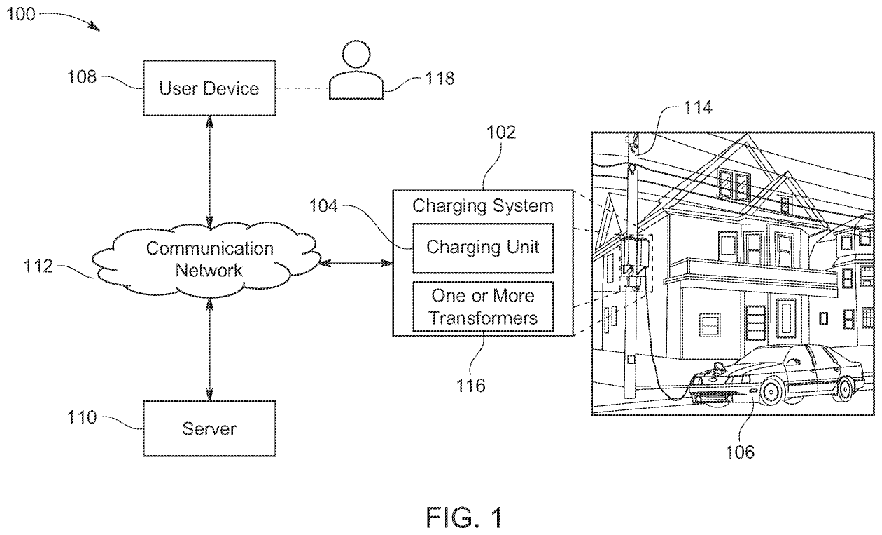

FIG. 1 illustrates an environment comprising a charging system for rapidly charging an electric vehicle, in accordance with an example embodiment. With reference to FIG. 1, there is shown an environment 100 that may include a charging system 102 for rapidly charging a vehicle.

As illustrated in FIG. 1, the environment 100 may comprise the charging system 102, a charging unit 104, a vehicle 106, a user device 108, a server 110, and a communication network 112. The charging unit 104 may be mounted on a pole 114. In an embodiment, the charging system 102 may include one or more transformers 116. Additional, fewer, or different components may be provided. For example, a proxy server, a name server, a map server, a cache server or cache network, a router, a switch or intelligent switch, a database, additional computers or workstations, administrative components, such as an administrative workstation, a gateway device, a backbone, ports, network connections, and network interfaces may be provided. While the components in FIG. 1 are shown as separate from one another, one or more of these components may be combined. In this regard, the charging system 102 may be communicatively coupled to the components shown in FIG. 1 to carry out the desired operations and wherever required modifications may be possible within the scope of the present disclosure.

The charging system 102 may include suitable logic, circuitry, interfaces, and/or code that may be configured to control the charging unit 104 to rapidly charge the vehicle 106. The charging system 102 may be configured to receive an input voltage from one or more power lines or wires supported by the pole 114 and feed the received voltage to one or more transformers 116. In an embodiment, the charging system 102 may be adaptable according to various levels of charging defined by at least one of the National Traffic and Safety Administration (NTSA®), the Society of Automotive Engineers (SAE®) and the International Electro-technical Commission (IEC®). As of now, three levels of charging of EVs are known. These levels may be Level-1, Level-2, and Level-3. Level-1 charging may be the slowest and may use a standard 120V outlet, providing up to 4 miles of range per hour of charging. Level-2 charging may be faster than Level-1 charging and may use a 240V outlet, providing up to 25 miles of range per hour of charging. Level-3 charging may be the fastest charging and may use direct current (DC) fast charging, providing up to 300 miles of range per hour of charging. The disclosed charging system 102 may be able to provide output voltage according to the levels known in the art or levels to be added in the future.

The charging unit 104 may include suitable logic, circuitry, interfaces, electrical components, and/or code that may be configured to charge the vehicle 106. The charging unit 104 may be controlled by the charging system 102. In an embodiment, the charging unit 104 may be configured to receive one or more user inputs from the user 118 of the vehicle 106 via a display screen that may be associated with the charging unit 104. Based on the reception of the one or more user inputs, the charging unit 104 may be configured to charge the vehicle 106 and/or stop the charging of the vehicle 106.

The vehicle 106 may refer to an autonomous, semi-autonomous or manual automotive vehicle that may be capable of carrying one or more human occupants and may be powered entirely or partially by an electric battery and/or any form of energy that can be recharged at a charging station. The electric battery may include battery electric vehicles (BEV) and plug-in hybrid electric vehicles (PHEV). Energy used to propel electric vehicles may come from various sources, such as, but not limited to, an on-board rechargeable battery and/or an on-board fuel cell. In one embodiment, the electric vehicle may a hybrid electric vehicle, which may capture and store energy generated by braking. Moreover, the hybrid electric vehicle uses energy stored in an electrical source, such as a battery, to continue operating when idling to conserve fuel. Some hybrid electric vehicles are capable of recharging the battery by plugging into a power receptacle, such as a general power outlet. Accordingly, the term “electric vehicle” as used herein may refer to a hybrid electric vehicle or any other vehicle to which electrical energy may be delivered, for example, via the power grid. The term “electric vehicle” can include, but is not limited to: four wheelers such as a car, a truck, a van, a minivan, and a sports utility vehicle (SUV), two-wheelers such as a motorcycle and a scooter, a boats, a personal watercraft, and an aircraft.

The user device 108 may include suitable logic, circuitry, interfaces, and/or code that may be configured to receive one or more notifications/messages from the charging system 102. In an embodiment, the user device 108 may be associated with a user 118 who may be an owner of the vehicle 106 or driving the vehicle 106. In some embodiments, the user device 108 may be configured to provide an interface that may be utilized by the user 118 to provide one or more inputs associated with charging of the vehicle 106. In an embodiment, the user 118 may be able to control one or more parameters of charging while charging the vehicle 106 via the user device 108. Examples of the user device 108 may include, but are not limited to, a smartphone, a cellular phone, a mobile phone, a gaming device, a consumer electronic (CE) device, a computing device, a computer work-station, a mainframe machine, and/or a server.

The server 110 may include suitable logic, circuitry, and interfaces, and/or code that may be configured to store the one or more parameters of charging. The server 110 may be further configured to store the one or more inputs that may be received from the user 118 via the user device 108. In an example, the server 110 may be configured to control a parameter “charging speed” of the vehicle 106. The server 110 may be implemented as a cloud server and may execute operations through web applications, cloud applications, hypertext transfer protocol (HTTP) requests, repository operations, file transfer, and the like. Other example implementations of the server 110 may include, but are not limited to, a database server, a file server, a web server, a media server, an application server, a mainframe server, or a cloud computing server.

In at least one embodiment, the server 110 may be implemented as a plurality of distributed cloud-based resources by use of several technologies that are well known to those ordinarily skilled in the art. A person with ordinary skill in the art will understand that the scope of the disclosure may not be limited to the implementation of the server 110 and the charging system 102 as two separate entities. In an embodiment, the operations of the charging system 102 may be performed by the server 110. In certain embodiments, the functionalities of the server 110 can be incorporated in its entirety or at least partially in the charging system 102, without a departure from the scope of the disclosure.

The communication network 112 may include a communication medium through which the charging system 102, the vehicle 106, the user device 108, and the server 110 may communicate with each other. The communication network 112 may be one of a wired connection or a wireless connection. Examples of the communication network 112 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the environment 100 may be configured to connect to the communication network 112 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The pole 114 may be a tall structure that may be used to support overhead power lines and other types of utilities, such as phone lines and cables. Specifically, the pole 114 may be a utility pole or a streetlight pole. Multiple poles may be installed in an area that may form an essential part of the electricity grid, providing a safe and reliable way to transmit electricity to homes and businesses. In an embodiment, the pole 114 may be typically made of wood, metal, or concrete and may be anchored deep into the ground to provide stability.

Each of the one or more transformers 116 may correspond to an inductive electrical device that may be capable of changing a voltage of an alternating current. Each of the one or more transformers 116 may be used to transfer electrical energy from one circuit to another through the principle of electromagnetic induction. Each of the one or more transformers 116 may include two coils, known as a primary coil and a secondary coil that may be wound around a magnetic core. When the alternating current flows through the primary coil, it generates a magnetic field that induces a voltage across the secondary coil. This voltage may then be used to power another circuit or device (such as the vehicle 106 or the charging outlet). Each of the one or more transformers 116 may either be a step-down transformer, or a step-up transformer, or a combination of both or an isolation transformer. The step-down transformer may convert the voltage of the alternating current to a lower voltage whereas the step-down transformer may convert the voltage of the alternating current to a higher voltage. The isolation transformer may not convert any voltage levels. The primary voltage and the secondary voltage of the isolation transformer always remain the same.

In operation, the user 118 may wish to charge the vehicle 106. As discussed above, the vehicle 106 may be an electric vehicle. The user 118 may park the vehicle 106 near the pole 114. In an embodiment, the charging unit 104 may be mounted on the pole 114. The charging unit 104 may be part of the charging system 102 and may be enclosed in an enclosure that may be made up from one or more of metal or plastic or wood. The charging unit 104 may further include the one or more transformers 116. In an embodiment, at least one of the one or more transformers 116 may be connected with the one or more power lines that may be supported by the pole 114 to receive an input voltage.

The one or more transformers 116 may intake the input voltage and change the voltage from a first value to a second value. Specifically, the first voltage may correspond to the input voltage and the second voltage may be suitable for the charging of the vehicle 106. In one embodiment, each of the one or more transformers 116 may be a 277/240 volts transformer that may be capable of stepping down the 277V (first value) which may be typically used to power street and parking lot lights to 240V (second value) which may suitable for most electric vehicles including the vehicle 106.

In an embodiment, the charging unit 104 may further include at least one charging outlet. The charging outlet may be coupled with the one or more transformers 116 via the cord. The charging outlet may be a device that may connect the vehicle 106 battery to a power source for recharging. The charging outlet may vary depending on the level of charging that may be required, which can range from lower level overnight charging for home use, to high speed charging stations that provide more rapid charging when on the road. Examples of different types of charging outlet may include, but are not limited to, a Society of Automotive Engineers (SAE)® J1772®s outlet, a Mennekes® outlet, a (GuoBiao/TuiJian) GB/T® outlet, a Combined Charging System (CCS)® outlet, a CHArge de MOve (CHAdeMO)® outlet, and other proprietary charging outlets. The charging outlet may be connectable to a charging port of the vehicle 106 and may charge the vehicle 106 for a first time-period. Details about charging of the vehicle are provided, for example, in FIG. 7.

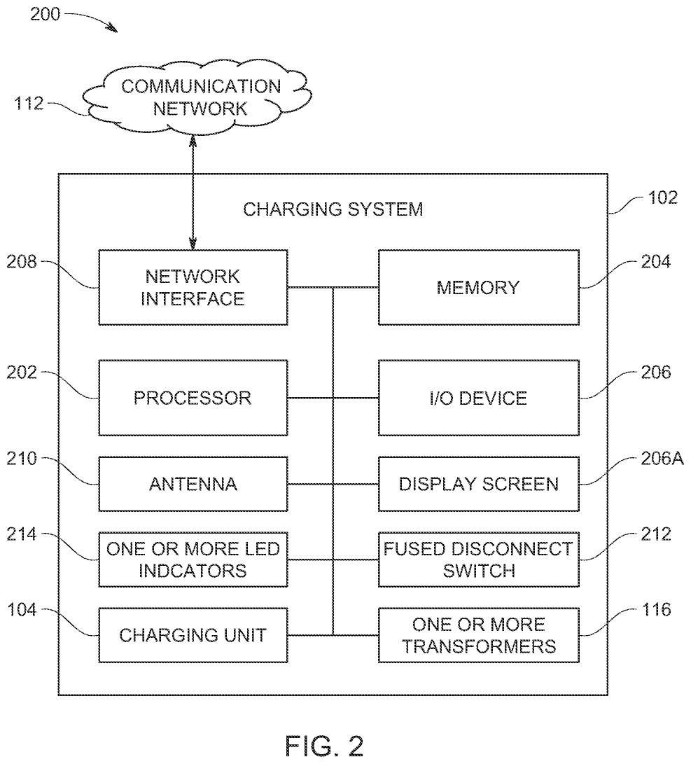

FIG. 2 illustrates an exemplary block diagram of the charging system, in accordance with one or more example embodiments. FIG. 2 is explained in conjunction with FIG. 1. With reference to FIG. 2, there is shown a block diagram 200 of the charging system 102.

The charging system 102 may include at least one processor 202, a memory 204, an input/output (I/O) interface 206 and a network interface 208. In accordance with an embodiment, the charging system 102 may further include a display screen 206A, an antenna 210, a fused disconnect switch 212, one or more LED indicators 214, the charging unit 104, and the one or more transformers 116.

The processor 202 may comprise suitable logic, circuitry, and interfaces that may be configured to execute instructions stored in the memory 204. The executed instructions may correspond to controlling the movement of the cord along with the charging outlet based on the reception of the first user input and the second user input respectively. In some embodiments, the processor 202 may be further configured to control the flow of electricity from the charging unit 104 to the vehicle 106. In an embodiment, the processor 202 may be further configured to calculate an amount to be paid by a user of the vehicle for charging the vehicle 106 and receive confirmation information associated with a successful payment of the calculated amount. The processor 202 may be implemented based on a number of processor technologies known in the art. Examples of the processor 202 may include, but are not limited to, a Graphical Processing Unit (GPU), a co-processor, a Central Processing Unit (CPU), x86-based processor, a Reduced Instruction Set Computing (RISC) processor, an Application-Specific Integrated Circuit (ASIC) processor, a Complex Instruction Set Computing (CISC) processor, and a combination thereof.

The memory 204 may include suitable logic, circuitry, and/or interfaces that may be configured to store the program instructions executable by the processor 202. Additionally, the memory 204 may store the received one or more user inputs, the user profile, the payment information, and the calculated first amount. In another embodiment, the memory 204 may further store information about an amount of the electricity consumed by the vehicle 106, and data corresponding to the first time-period. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O interface 206 may comprise suitable logic, circuitry, and/or devices that may be configured to act as an I/O channel between the user 118 and the charging system 102. The I/O interface 206 may be configured to receive one or more user inputs. In some embodiments, the charging system 102 may receive user input such as the first user input and the second user input, via the I/O interface 206. The I/O interface 206 may comprise various input and output devices, which may be configured to communicate with different operational components of the charging system 102. Examples of the I/O interface 206 may include, but are not limited to, a touch screen, a keyboard, a mouse, a joystick, a microphone, and a display screen (for example, the display screen 206A).

The display screen 206A may comprise suitable logic, circuitry, and interfaces that may be configured to display information associated with the charging system 102. In an embodiment, the display screen 206A may further display the calculated first amount that may have to be paid by the user 118 for charging their vehicle 106. In some embodiments, the display screen 206A may be an external display device that may be associated with the charging system 102. The display screen 206A may be a touch screen which may enable the user to provide the user input (such as the first user input and the second user input) via the display screen 206A. The touch screen may be at least one of a resistive touch screen, a capacitive touch screen, or a thermal touch screen. The display screen 206A may be realized through several known technologies such as, but are not limited to, at least one of a Liquid Crystal Display (LCD) display, a Light Emitting Diode (LED) display, a plasma display, or an Organic LED (OLED) display technology, or other display devices. In accordance with an embodiment, the display screen 206A may refer to a display screen of a head mounted device (HMD), a smart-glass device, a see-through display, a projection-based display, an electro-chromic display, or a transparent display.

The network interface 208 may comprise suitable logic, circuitry, interfaces, and/or code that may be configured to establish communication between the charging system 102, the user device 108, and the server 110, via the communication network 112. The network interface 208 may be configured to implement known technologies to support wired or wireless communication. The network interface 208 may include, but is not limited to, an antenna (such as the antenna 210), a radio frequency (RF) transceiver, one or more amplifiers, a tuner, one or more oscillators, a digital signal processor, a coder-decoder (CODEC) chipset, a subscriber identity module (SIM) card, and/or a local buffer.

The network interface 208 may be configured to communicate via offline and online wireless communication with networks, such as the Internet, an Intranet, and/or a wireless network, such as a cellular telephone network, a wireless local area network (WLAN), personal area network, and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), Long-Term Evolution (LTE), time division multiple access (TDMA), Bluetooth, Wireless Fidelity (Wi-Fi) (such as IEEE 802.11, IEEE 802.11b, IEEE 802.11g, IEEE 802.11n, and/or any other IEEE 802.11 protocol), voice over Internet Protocol (VoIP), Wi-MAX, Internet-of-Things (IoT) technology, Machine-Type-Communication (MTC) technology, a protocol for email, instant messaging, and/or Short Message Service (SMS).

The charging system 102 may further include the antenna 210 (specifically a cellular antenna) for communicating with the server 110 and/or a software application that may be installed on the user device 108. In particular, the charging system 102 may include hardware and software for controlling the charging unit 104, such as a printed circuit board with the necessary hardware and software to manage payment and charging. Furthermore, the charging unit 104 may communicate, for example via the antenna 210, with the server 110 that may manage the charging system 104 or perform the operations of the charging system 102.

Additionally, the charging unit 104 may communicate with the user device 108. Such communication may be done via the antenna 210, either directly from the charging unit 104 or via the server 110. Alternatively, or additionally, the charging unit 104 may communicate with the user device 108 directly, via known communication protocols, such as, but not limited to, Bluetooth, Near-field communication (NFC), and the like. As such, the user may be able to operate the charging unit 104 either directly on the unit via the display screen 206A or a payment device and/or via the application installed on the user's device 108. In an embodiment, the antenna 210 may be a component of the network interface 208 and may be used to establish communication between various devices of the charging system 102.

The fused disconnect switch 212 may be an electrical device that may be used to disconnect electrical circuits from their power sources. The fused disconnect switch 212 may include a means of disconnection, either a handle or a lever, which can be used to open or close the switch, and a set of fuses that protect the electrical equipment from power surges or short circuits. In the event of an overload, the fuses will “blow” or break, cutting off the flow of electricity and protecting the equipment from damage. The fused disconnect switch 212 may be found in a variety of sizes, types, and ratings depending on the application and the load to be handled. In an embodiment, the fused disconnect switch 212 may be disposed between the output of the one or more power lines and the one or more transformers 116 and may control the input voltage to be provided as an input to the one or more transformers 116. In an embodiment, the fused disconnect switch 212 may be a 50 Ampere fused disconnect switch.

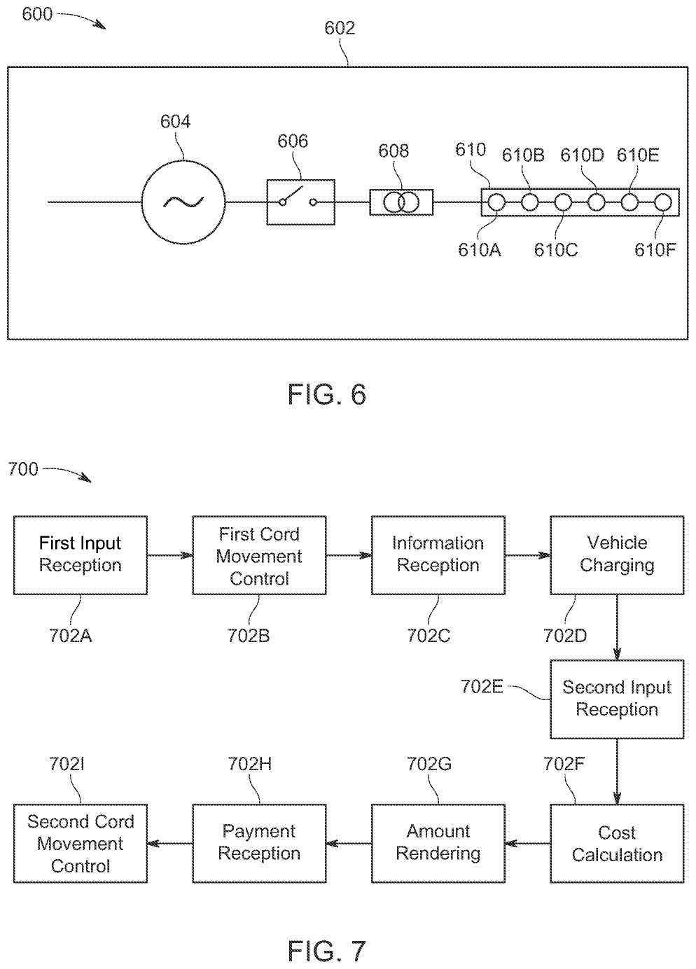

Each of the one or more LED indicators 214 may comprise suitable logic, circuitry, interfaces, and/or code that may be configured to indicate the status or activity of the charging system 102. In an embodiment, each of the one or more LED indicators 214 may operate on low voltage and may be energy-efficient. In an embodiment, each of the one or more LED indicators 214 may be configured to indicate information about a set of parameters associated with the charging unit 104. Examples of such parameters may include, but are not limited to, a charging unit state parameter, a network parameter, and a payment parameter. Details about the one or more LED indicators 214 and the set of parameters are provided, for example, in FIG. 6.

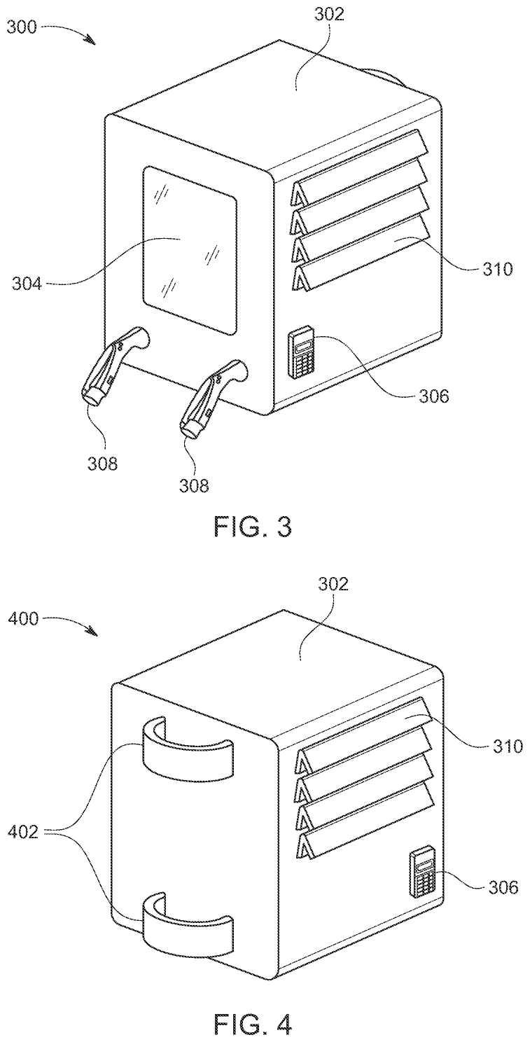

FIG. 3 is diagram that depicts a front perspective view of the charging unit of FIG. 1, in accordance with one or more example embodiments. FIG. 3 is explained in conjunction with elements from FIG. 1 and FIG. 2. With reference to FIG. 3, there is shown a front perspective view 300 of the charging unit 104. The charging unit 104 may be enclosed in an enclosure 302. There is further shown a display screen 304, a payment device 306, one or more charging outlets 308, and one or more ventilation openings 310. The display screen 304 may be an exemplary embodiment of the display screen 206A.

As shown, the charging unit 104 may be enclosed inside the enclosure 302. The enclosure 302 may be a type of protective case for charging unit 104 and may be designed to meet certain specifications that may be set by the National Electrical Manufacturers Association (NEMA). The enclosure 302 may be used to protect electronic devices from various environmental and physical hazards including moisture, dust, temperature fluctuations, and impact. The enclosure 302 may be formed of (or built from) one of a metal, a wood, or a plastic. In some embodiments, the enclosure 302 may be built from a combination of the metal, the wood, or the plastic. In an embodiment, the enclosure 302 may be a weatherproof metallic enclosure. In another embodiment, the enclosure 302 is an aluminum NEMA enclosure.

In an embodiment, the charging unit 104 may include a display screen 304 that may be visible on the enclosure 302. As discussed above, the display screen 304 may include a touch screen that may be capable of being interacted with by the user 118 of the charging system 102. The user 118 may interact with the touch screen to control the charging unit 104 in order to charge their vehicle 106.

In another embodiment, the charging unit 104 may further include the payment device 306 that may be mounted on the enclosure 302. The payment device 306 may comprise suitable logic, circuitry, interfaces, and/or code that may be configured to accept payments from the user 118 in order to provide charging to the user's vehicle 106. In an embodiment, the payment device 306 may be capable of accepting magnetic strip credit/debit cards, chip credit/debit cards, quick response (QR) codes, prepaid cards, vouchers, coupons, and/or contactless payment methods. In an embodiment, the charging unit 104 may also be capable of accepting payment remotely, for example, by way of the user 118 entering their payment information into a software application installed on the user device 108 and authorizing the payment to the charging unit 104 via the software application.

The charging unit 104 may include the one or more charging outlets 308 that may be capable of being electrically attached to the vehicle 106 via a power cord for charging purposes. Each of the one or more charging outlets 308 may further include power cord (also referred as the cord) reels to conveniently retract or provide upward traction to the power cord towards the charging unit 104 when not in use.

The enclosure 302 may include the one or more ventilation openings 310 to allow for airflow into and out of the enclosure 302 to allow for any heat generated by the charging unit 104 to be ventilated out of the enclosure 302 and into the surrounding air.

FIG. 4 is diagram that depicts a rear perspective view of the charging unit of FIG. 1, in accordance with one or more example embodiments. FIG. 4 is explained in conjunction with elements from FIG. 1, FIG. 2, and FIG. 3. With reference to FIG. 4, there is shown a rear perspective view 400 of the charging unit 104. The charging unit 104 may be enclosed in the enclosure 302. There is further shown a mounting mechanism 402, the payment device 306, and the one or more ventilation openings 310.

The charging unit 104 may be enclosed inside the enclosure 302. The enclosure 302 may be a type of protective case for charging unit 104 and may be designed to meet certain specifications that may be set by the National Electrical Manufacturers Association (NEMA). Details about the enclosure 302 are provided, for example, in FIG. 3.

In another embodiment, the charging unit 104 may further include the payment device 306 that may be mounted on the enclosure 302. The payment device 306 may comprise suitable logic, circuitry, interfaces, and/or code that may be configured to accept payments from the user 118 in order to charge to the user's vehicle 106. Details about the payment device 306 are provided, for example, in FIG. 3.

As discussed above, the enclosure 302 may include the one or more ventilation openings 310 to allow for airflow into and out of the enclosure 302 to allow for any heat generated by the charging unit 104 to be ventilated out of the enclosure 302 and into the surrounding air.

The enclosure 302 may further include the mounting mechanism 402, for example, straps to allow the enclosure 302 to be mounted to the existing utility pole or the existing streetlight pole. The mounting mechanisms 402 may be essential for ensuring that the enclosure 302 remains stable and secure in their intended position. Other examples of the mounting mechanisms 402 may include, but are not limited to, screws, bolts, clamps, brackets, and adhesives.

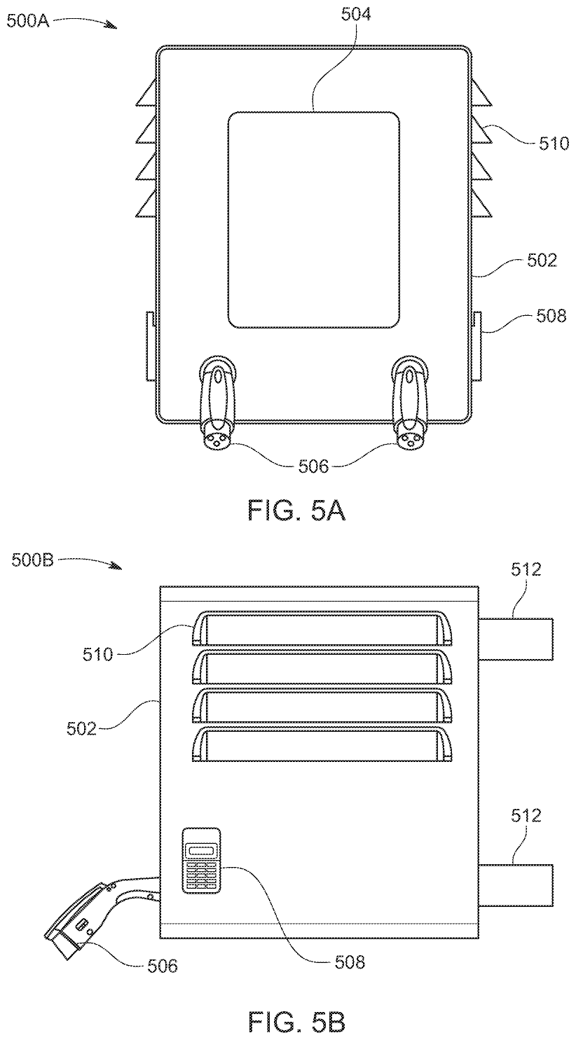

FIG. 5A is diagram that depicts a front view of the charging unit of FIG. 1, in accordance with one or more example embodiments. FIG. 5A is explained in conjunction with elements from FIG. 1, FIG. 2, FIG. 3, and FIG. 4. With reference to FIG. 5A, there is shown a front view 500A of the charging unit 104. The charging unit 104 may be enclosed in an enclosure 502 that may be an exemplary embodiment of the enclosure 502. There is further shown a display screen 504, and one or more charging outlets 506. The display screen 504 and the one or more charging outlets 506 may be an exemplary embodiment of the display screen 304 (or the display screen 206A) and the one or more charging outlets 308.

The charging unit 104 may be enclosed inside the enclosure 502. As discussed above, the enclosure 502 may be a type of protective case for charging unit 104 and may be designed to meet certain specifications that may be set by the National Electrical Manufacturers Association (NEMA). Details about the enclosure 502 are provided, for example, in FIG. 3.

The display screen 504 may include a touch screen that may be capable of being interacted with by the user 118 of the charging system 102. The user 118 may interact with the touch screen to control the charging unit 104 in order to charge the vehicle 106. As displayed in FIG. 5A, the display screen 504 may be rectangular in shape and may be integrated on a top side of the enclosure 502. In some other embodiment, the display screen 504 may take any form or may be of any size depending upon the implementation. In some other embodiment, the position of the display screen on the enclosure may be changed according to implementation details. Furthermore, in some embodiments, the display screen 504 may be separated from the charging unit 104 and may be mounted on the pole for easier assistance for the user 118. Details about the display screen 504 are provided, for example, in FIG. 3.

The charging unit 104 may include one or more charging outlets 506 that may be capable of being electrically attached to the vehicle 106 via a power cord for charging purposes. Each of the one or more charging outlets 506 may further include power cord reels to conveniently retract the power cord into the charging system 102 when not in use charging a vehicle 106. Typically, the cord may include a conductive core, an insulating layer, and an outer jacket. The conductive core may be made of copper, aluminum, or a combination of both. The insulating layer may be made of plastic or rubber, and its purpose is to prevent electrical current from flowing out of the cord and into surrounding materials. The outer jacket may be made up of durable materials such as PVC or nylon, and may provide a protective layer for the cord against physical damage, moisture, and chemicals. Details about the one or more charging outlets 506 are provided, for example, in FIG. 1.

FIG. 5B is diagram that depicts a side view of the charging unit of FIG. 1, in accordance with one or more example embodiments. FIG. 5B is explained in conjunction with elements from FIG. 1, FIG. 2, FIG. 3, FIG. 4, and FIG. 5A. With reference to FIG. 5B, there is shown a side view 500B of the charging unit 104. The charging unit 104 may be enclosed in the enclosure 502. There is further shown a payment device 508, a ventilation opening 510, and mounting mechanism 512.

The payment device 508 may comprise suitable logic, circuitry, interfaces, and/or code that may be configured to accept payments from the user 118 in order to charge the user's vehicle 106. In an embodiment, the payment device 508 may include a display screen that may assist the user 118 in payments. In another embodiment, the payment device 508 may further include an image sensor that may be configured to capture a face of the user 118 that may be used to authenticate the user 118 for making payments via a bank account associated with the user 118. The payment device 508 may also include a card reader that may be able to read credit and debit card information a transaction. Details about the payment device 508 are provided, for example, in FIG. 3.

As discussed above, the enclosure 502 may include ventilation openings 510 to allow for airflow into and out of the enclosure 502 to allow for any heat generated by the charging unit 104 to be ventilated out of the enclosure 502 and into the surrounding air. As discussed above, the charging unit 102 may include the one or more transformers 116 that may radiate heat while in operation. The heat generated by the one or more transformers 116 may be accumulated inside the enclosure 502. Such accumulated heat may damage the enclosure 502 and may have to be ventilated out. In some embodiments, the charging unit 104 may also radiate heat. Therefore, the ventilation openings may be present in the enclosure 502 to emit the heat generated by the one or more transformers 116 and/or the charging unit 104.

The enclosure 502 may further include the mounting mechanism 512, for example straps, to allow the enclosure 302 to be mounted to an existing utility pole 114 or the streetlight pole 114. Details about the mounting mechanism 512 are provided, for example, in FIG. 4.

FIG. 6 is diagram that depicts a line drawing of the charging unit of FIG. 1, in accordance with one or more example embodiments. FIG. 6 is explained in conjunction with elements from FIG. 1, FIG. 2, FIG. 3, FIG. 4, FIG. 5A, and FIG. 5B. With reference to FIG. 6, there is shown a line drawing 600 of a charging unit 602 of the charging system 102. There is further shown a voltage input source 604, a fused disconnect switch 606, one or more transformers 608, and a set of light emitting diode (LED) indicators 610. The set of LED indicators 610 may include, but are not limited to, a first LED indicator 610A, a second LED indicator 610B, a third LED indicator 610C, a fourth LED indicator 610D, a fifth LED indicator 610E, and a sixth LED indicator 610F.

The charging unit 602 may be mounted on the pole 114 that may support overhead power lines (e.g., the one or more power lines). Such power lines may carry the electric power over large distances. The output of the one or more power lines may be provided as the input to the charging unit 602 via the voltage input source 604. In an embodiment, the voltage input source 604 may be provided to the charging unit 602 by electrically connecting the charging unit 602 to the voltage input source 604. As a first example, the electric power may correspond to 277 volts (or 277V) and the same voltage may be provided as the input to the voltage input source 604.

The fused disconnect switch 606 may be disposed between the output of the one or more power lines and the one or more transformers 608. Thus, the fused disconnect switch 606 may be connected between the voltage input source 604 and the one or more transformers 608. The fused disconnect switch 606 (also referred as a combination switch or a safety switch), may be an electrical device that may be used to control and isolate electrical circuits. The fused disconnect switch 606 may be designed to provide a safe and convenient means of disconnecting power to a piece of equipment (such as the one or more transformers 608) or an entire electrical system. The fused disconnect switch 606 may include two main components, a switch and a fuse. The switch may be used to interrupt the flow of electrical power, while the fuse may be designed to protect the electrical system from overcurrent conditions (such as a sudden hike in the voltage). With reference to the first example, the fused disconnect switch 606 may correspond to a 50 Ampere fusible disconnect switch.

Each of the one or more transformers 608 may be configured to receive an input voltage of a first value from the voltage input source 604 via the fused disconnect switch 606. In some embodiments, each of the one or more transformers 608 may be further configured to convert the input voltage of the first value to a second value. The second value of the voltage may be less than the first value voltage in case each of the one or more transformers 608 is a step-down transformer. Alternatively, the second value of the voltage may be greater than the first value voltage in case each of the one or more transformers 608 is a step-up transformer. In some embodiments where each of the one or more transformers 608 is an isolation transformer, the second value of voltage may be same as the first value of voltage. With reference to the first example, each of the one or more transformers 608 may correspond to the step down transformer that may be configured to change the input voltage of 277V to 240V which may accepted by most electric vehicles including the vehicle 106.

Each of the set of light emitting diode (LED) indicators 610 may correspond to an electronic component that may be used in various devices (such as the charging unit 602) to display information or status associated with the charging unit 602. Each of the set of LED indicators 610 may be a small light, typically colored, that may be designed to indicate different conditions of the charging unit 602 such as when the charging unit 602 is turned on, charging or low battery. Specifically, each of the set of light emitting diode (LED) indicators 610 may be configured to indicate information about the set of parameters associated with the charging unit 602. For example, set of parameters associated with the charging unit 602 may include, but are not limited to, a charging unit state parameter, a network parameter, and a payment parameter.

By way of example and not limitation, the first LED indicator 610A may be associated with the charging unit state parameter and may indicate whether the charging unit 602 may be in a working condition or not. For example, if the first LED indicator is 610A is green in color, then the charging unit 602 may be in the working condition. Otherwise, if the first LED indicator is 610A is red in color, then the charging unit 602 may be in the non-working condition. The second LED indicator 610B may be associated with the network parameter and may indicate whether the charging unit 602 is connected to the server 110 via the communication network 112. The third LED indicator 610C may be associated with the payment parameter and may indicate whether the payment device 306 is working or not. The fourth LED indicator 610D may be associated with the charging unit state parameter and may indicate whether the charging unit 602 is functioning and currently providing the charge to the vehicle 106. In an embodiment, the fifth LED indicator 610E, and the sixth LED indicator 610F may be used reserved for future purposes to indicate other parameters associated with the charging system 102.

FIG. 7 is a diagram that illustrates exemplary operations for charging a vehicle using the charging system, in accordance with an embodiment of the disclosure. FIG. 7 is explained in conjunction with elements from FIG. 1, FIG. 2, FIG. 3, FIG. 4, FIG. 5A, FIG. 5B, and FIG. 6. With reference to FIG. 7, there is shown a block diagram 700 that illustrates exemplary operations from 702A to 7021, as described herein. The exemplary operations illustrated in the block diagram 700 may start at 702A and may be performed by any computing system, apparatus, or device, such as by the charging system 102 of FIG. 1 or the processor 202 of FIG. 2. Although illustrated with discrete blocks, the exemplary operations associated with one or more blocks of the block diagram 700 may be divided into additional blocks, combined into fewer blocks, or eliminated, depending on the particular implementation.

At 702A, a first input reception operation may be performed. In the first input reception operation, the charging system 102 may be configured to receive a first user input from the user 118. The first user input may be associated with an initiation of charging of the vehicle 106 and may be received from at least one of an application installed on the user device 108 or from the display screen 206A that may be integrated within the charging unit 104 of the charging system 102. In an embodiment, a quick response (QR) code may be rendered on the display screen 206A that the user 118 may have to scan via their user device 108. Once scanned, the charging system 102 may receive the first user input associated with initiation of charging of the vehicle 106.

At 702B, a first cord movement control operation may be performed. In the first cord movement control operation, the charging system 102 may be configured to control a movement of a cord connected to the charging outlet 506. The movement of the cord along with the charging outlet 506 may be based on the reception of the first user input. The movement of the cord may correspond to a downward traction of the cord along with the charging outlet 506. For example, the operation involves downward traction of the cord associated with one outlet of the charging outlet 506, for one vehicle, such as the vehicle 106. As the charging unit 104 may be mounted on the pole 114 above a pre-determined height (say 10 feet) to keep the charging unit 104 safe from being stolen or damage, the charging system 102 may be configured to control the movement of the cord to drop the cord towards the ground so that the user 118 may be able to plug the charging outlet 506 associated with an end of the cord into the charging port of the vehicle 106.

At 702C, an information reception operation may be performed. In the information reception operation, the charging system 102 may be configured to receive connection information. The connection information may be received from at least one of the charging outlet 506, the user device 108, or the display screen 206A. The connection information may indicate that the charging outlet 506 is securely connected with the charging port of the vehicle 106. In an embodiment, one or more sensors may be integrated within the charging outlet 506 that may be configured to detect when the charging outlet 506 is securely connected with the charging port of the vehicle 106 and transmit the connection information to the charging system 102. In another embodiment, the user 118 may plug the charging outlet 506 into the charging port of the vehicle 106 and then provide the input associated with the connection information manually using the application installed on the user device 108 or via the display screen 206A associated with the charging unit 104.

At 702D, a vehicle charging operation may be performed. In the vehicle charging operation, the charging system 102 may be configured to control a flow of electricity from the charging unit 104 to the vehicle 106 via the cord to provide the charge to the vehicle 106. In an embodiment, the charging system 102 may be configured to control the flow of electricity for a first time-period. The first time-period may be a pre-defined time period (say for 1 hour or 3 hours) that may be set according to guidelines from various manufacturers of vehicles or based on government guidelines. The charging system 102 may charge the vehicle 106 for the first time period. In another embodiment, the first time period may be received from the user 118 in the first user input. In case the user 118 wants to charge the vehicle 106 for 30 minutes, then the user 116 may be able to provide the first user input that may include the first time period of 30 minutes. Accordingly, the charging system 102 may control the flow of electricity from the charging unit 104 to the vehicle 106 via the cord to provide the charge to the vehicle 106 for 30 minutes as specified in the first user input.

At 702E, a second input reception operation may be performed. In the second input reception operation, the charging system 102 may be configured to receive a second user input. The second user input may be associated with an ending or stopping of charging of the vehicle 106. In an embodiment, the second user input may be received via at least one of the user device 108 or the display screen 206A. In another embodiment, the second user input may be received via the charging outlet 506. Based on the reception of the second user input, the charging system 102 may be configured to control the flow of electricity from the charging unit 104 to the charging port of the vehicle 106 based on the reception of the second user input. The flow of electricity may be controlled to stop the charging of the vehicle 106 after the first time-period or at the time of reception of the second user input.

Although it is shown that the first user input reception and the second user input reception operation are different, the disclosure is not so limited. In some embodiments, the second user input may be received, along with the first user input, in the first user input reception operation.

At 702F, a cost calculation operation may be performed. In the cost calculation operation, the charging system 102 may be configured to calculate an amount to be charged to the user 118 for charging the vehicle 106. In an embodiment, the amount may be calculated based on one or more factors that may be associated with at least one of an electricity consumed by the vehicle 106 during charging, the first time-period, and a user profile of the user 118 associated with the vehicle 106. In an embodiment, the calculated amount may be based on the user profile. In case the user 118 is a regular customer, or have a membership, then a discount may be given to the user 118.

At 702G, an amount rendering operation may be performed. In the amount rendering operation, the charging system 102 may be configured to render the calculated amount on the display screen 206A or on the user device 108. In an embodiment, a break-up of the calculated amount may also be rendered on the display screen 206A or on the user device 108.

At 702H, a payment reception operation may be performed. In the payment reception operation, the charging system 102 may be configured to receive payment of the calculated amount from the user 118. In an embodiment, the charging system 102 may be configured to receive the payment of the calculated amount form the user device 108 or the payment device 306 mounted on the enclosure of the charging unit 104. Based on the reception of the payment, the charging system 102 may be configured to receive confirmation information associated with a successful payment of the calculated amount from at least one of the user device 108, the payment device 306, or the server 110.

In another embodiment, the processor 202 may be further configured to receive disconnection information from at least one of the charging outlet 506, the user device 108, or the display screen 206A. The disconnection information may indicate that the charging outlet 506 is disconnected from the charging port of the vehicle 106 after the first time-period. In an embodiment, the user 118 may be able to pull out the charging outlet 506 from the charging port of the vehicle only after the reception of the payment of the calculated amount. After pulling out the charging outlet 506 from the charging port of the vehicle, the disconnection information may be transmitted to the charging system 102 by the charging outlet 506 or from the user device 108 or the display screen 206A in case the user 106 manually provides a third user input associated with the disconnection of the charging outlet 506 from the charging port.

At 702I, a second cord movement control operation may be performed. In the second cord movement control operation, the charging system 102 may be configured to control the movement of the cord along with the charging outlet 506 based on the reception of the confirmation information and the reception of the disconnection information. In such movement of the cord, the charging system 102 may be configured to retract or provide upward traction to the cord along with the charging outlet 506 towards the charging unit 104 that may be mounted on the pole 114.

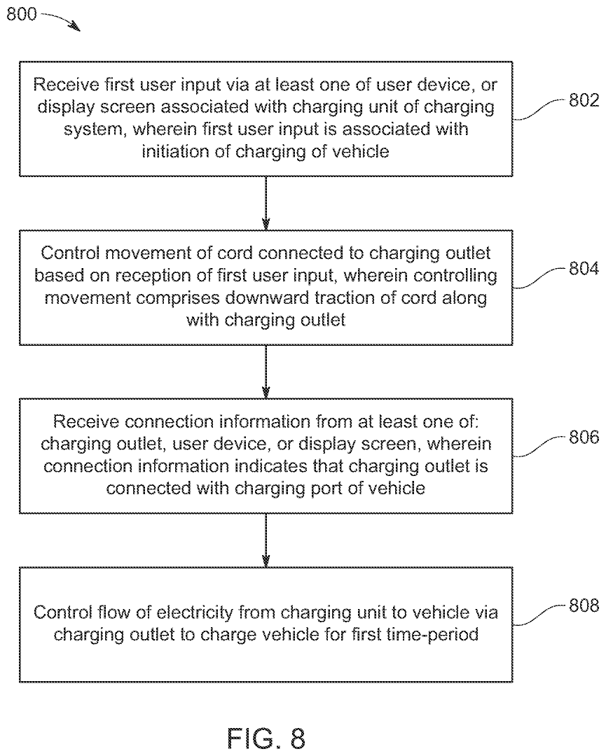

FIG. 8 is a flowchart that illustrates an exemplary method for charging of a vehicle, in accordance with an embodiment of the disclosure. FIG. 8 is explained in conjunction with elements from FIGS. 1, 2, 3, 4, 5A, 5B, 6, and 7. With reference to FIG. 8, there is shown a flowchart 800. The operations of the exemplary method may be executed by any computing system, for example, by the charging system 102 of FIG. 1 or the processor 202 of FIG. 2. The operations of the flowchart 800 may start at 802.

At 802, a first user input may be received. The first user input may be received via at least one of the user device 108, or the display screen 206A associated with charging unit 104 of charging system 102. The first user input may be associated with an initiation of a charging of the vehicle 106. In accordance with an embodiment, the processor 202 may be configured to receive the first user input via at least one of the user device 108, or the display screen 206A associated with the charging unit 104 of the charging system 102, wherein the first user input is associated with an initiation of a charging of the vehicle 106. Details about the first user input are provided, for example, in FIGS. 1 and 7.

At 804, a movement of the cord connected to the charging outlet 506 may be controlled. The movement of the cord connected with the charging outlet 506 may be controlled based on the reception of the first user input. The controlling of the movement may include a downward traction of the cord along with the charging outlet 506. In accordance with an embodiment, the processor 202 may be configured to control the movement of the cord connected to the charging outlet 506 based on the reception of the first user input. Details about the controlling the movement of the cord are provided, for example, in FIGS. 1 and 7.

At 806, connection information may be received. The connection information may be received from at least one of the charging outlet 506, the user device 108, or the display screen 206A. The connection information may indicate that charging outlet 506 is connected with the charging port of vehicle 106. In accordance with an embodiment, the processor 202 may be configured to receive the connection information from at least one of the charging outlet 506, the user device 108, or the display screen 206A. Details about the connection information are provided, for example, in FIG. 7.

At 808, a flow of electricity from the charging unit 104 to the vehicle 106 via the charging outlet 506 may be controlled to charge the vehicle 106 for a first time-period. In accordance with an embodiment, the processor 202 may be configured to control the flow of electricity from the charging unit 104 to the vehicle 106 via the charging outlet 506 to charge the vehicle 106 for the first time-period. Details about the flow of electricity are provided, for example, in FIG. 7. Control may pass to end.

The method 800 may be implemented using a corresponding processor. For example, the method 800 may be implemented by an apparatus or system comprising a processor, a memory, and a network interface of the kind discussed in conjunction with FIG. 2.

In some example embodiments, a computer programmable product may be provided. The computer programmable product may comprise at least one non-transitory computer-readable storage medium having stored thereon computer-executable program code instructions that when executed by a computer, cause the computer to execute the method 800.

In an example embodiment, a charging system for performing the method 800 of FIG. 8 above may comprise processor (e.g. the processor 202) configured to perform some or each of the operations of the method of FIG. 8 described previously. The processor may, for example, be configured to perform the operations (802-808) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (802-808) may comprise, for example, the processor 202 which may be implemented in the charging system 102 and/or a device or circuit for executing instructions or executing an algorithm for processing information as described above.

Returning to FIG. 1, the communication network 112 may be wired, wireless, or any combination of wired and wireless communication networks, such as cellular, Wi-Fi, internet, local area networks, or the like. In some embodiments, the communication network 112 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In an example, the charging system 102 may be embodied as a cloud based service, a cloud based application, a cloud based platform, a remote server based service, a remote server based application, a remote server based platform, or a virtual computing system. In yet another example embodiment, the charging system 102 may be an OEM (Original Equipment Manufacturer) cloud. The OEM cloud may be configured to anonymize any data received by the charging system 102, before using the data for further processing.

In some embodiments, the processor 202 may be configured to provide Internet-of-Things (IoT) related capabilities to users of the charging system 102 disclosed herein. The IoT related capabilities may in turn be used to provide smart city solutions by providing real time navigation output, big data analysis, and sensor-based data collection by using the cloud based mapping system for determining the difficulty factor for the geographic zone. The I/O interface 206 may provide an interface for accessing various features and data stored in the charging system 102.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A charging system comprising:
a charging unit comprising:
an enclosure for the charging unit, wherein the enclosure is to be mounted on a pole;
one or more transformers coupled with one or more power lines supported by the pole to receive an input voltage; and
at least one charging outlet coupled with the one or more transformers, wherein the charging outlet is connectable to a charging port of a vehicle to provide charge to the vehicle for a first time-period.

2. The charging system of claim 1, further comprises one or more processors configured to:
receive a first user input via at least one of: a user device, or a display screen associated with the charging unit, wherein the first user input is associated with an initiation of charging of the vehicle;
control a movement of a cord connected to the charging outlet based on the reception of the first user input, wherein controlling the movement comprises downward traction of the cord along with the charging outlet;
receive connection information from at least one of: the charging outlet, the user device, or the display screen, wherein the connection information indicates that the charging outlet is connected with the charging port of the vehicle; and
control a flow of electricity from the charging unit to the vehicle via the charging outlet to charge the vehicle for the first time-period.

3. The charging system of claim 2, wherein the one or more processors are further configured to:
receive a second user input via at least one of: the user device or the display screen associated with the charging unit, wherein the second user input is associated with an stoppage of charging of the vehicle;
control the flow of electricity from the charging unit to the charging port of the vehicle based on the reception of the second user input, to stop the charging of the vehicle after the first time-period;
receive disconnection information from at least one of: the charging outlet, the user device, or the display screen, wherein the disconnection information indicates that the charging outlet is disconnected from the charging port of the vehicle after the first time-period; and
control the movement of the cord based on the reception of the received disconnection information, wherein controlling the movement comprises upward traction of the cord along with the charging outlet.

4. The charging system of claim 3, wherein the one or more processors are further configured to:
calculate an amount to be paid by a user of the vehicle based on one or more factors;
render the calculated amount on at least one of: the user device or the display screen;
receive confirmation information associated with a successful payment of the calculated amount; and
control the movement of the cord based on the reception of the received disconnection information and the confirmation information.

5. The charging system of claim 4, wherein the one or more factors are associated with at least one of: an electricity consumed by the vehicle, the first time-period, and a user profile of a user associated with the vehicle.

6. The charging system of claim 1, further comprises a payment device mounted on the enclosure, wherein the payment device is configured to accept one or more payments via at least one of: a credit card, a debit card, a prepaid card, a quick response (QR) code, a radio-frequency identification (RFID) card, a voucher code, a coupon code, or a contactless payment method.

7. The charging system of claim 1, further comprises a fused disconnect switch disposed between an output of the one or more power lines and the one or more transformers.

8. The charging system of claim 7, wherein the fused disconnect switch is a 50 Amperes fusible disconnect switch.

9. The charging system of claim 1, wherein the one or more transformers corresponds to one of: a step-up transformer, a step-down transformer, or an isolation transformer.

10. The charging system of claim 9, wherein the one or more transformers corresponds to a 277/240 volts transformer.

11. The charging system of claim 1, wherein the charging unit further comprises a printed circuit board with an onboard software, and wherein one or more processors are configured to utilize the onboard software to perform operations associated with the charging unit.

12. The charging system of claim 1, wherein the enclosure is formed of one of: a metal, a wood, or a plastic.

13. The charging system of claim 1, wherein the enclosure comprises one or more ventilation vents.

14. The charging system of claim 1, wherein the charging unit further comprises a set of light emitting diode (LED) indicators configured to indicate information about a set of parameters associated with the charging unit.

15. The charging system of claim 14, wherein the set of parameters associated with the charging unit comprises at least one of: a charging unit state parameter, a network parameter, and a payment parameter.

16. The charging system of claim 1, further comprises a server in communication with the charging unit via a communication network, and wherein the server is configured to perform operations associated with the charging unit.

17. The charging system of claim 1, wherein the pole corresponds to one of: a utility pole or a streetlight pole.

18. A method comprising:
receiving a first user input via at least one of: a user device, or a display screen associated with a charging unit of a charging system, wherein the first user input is associated with an initiation of charging of a vehicle;
controlling a movement of a cord connected to a charging outlet of the charging system, based on the reception of the first user input, wherein controlling the movement comprises downward traction of the cord along with the charging outlet;
receiving connection information from at least one of: the charging outlet, the user device, or the display screen, wherein the connection information indicates that the charging outlet is connected with the charging port of the vehicle; and
controlling a flow of electricity from the charging unit to the vehicle via the charging outlet to charge the vehicle for a first time-period.

19. The method of claim 18, further comprising:
receiving a second user input via at least one of: the user device or the display screen associated with the charging unit, wherein the second user input is associated with a stoppage of charging of the vehicle;
controlling the flow of electricity from the charging unit to the charging port of the vehicle based on the reception of the second user input, to stop the charging of the vehicle after the first time-period;
receiving disconnection information from at least one of: the charging outlet, the user device, or the display screen, wherein the disconnection information indicates that the charging outlet is disconnected from the charging port of the vehicle after the first time-period; and
controlling the movement of the cord based on the reception of the received disconnection information, wherein the controlling the movement comprises upward traction of the cord along with the charging outlet.

20. The method of claim 19, further comprising:
calculating an amount to be paid by a user of the vehicle based on one or more factors;
rendering the calculated amount on at least one of: the user device or the display screen;
receiving confirmation information associated with a successful payment of the calculated amount; and
controlling the movement of the cord along with the charging outlet based on the reception of the received disconnection information and the confirmation information.
